(19) United States
(12) Patent Application Publication
(10) Pub. No.: US 2004/0064318 A1
(43) Pub. Date: Apr. 1, 2004

(54) Method for configuring a user interface

(76) Inventors: Meinrad Niemoeller, Holzkirchen (DE); Tobias Schneider, Muenchen (DE)

Correspondence Address: BELL, BOYD & LLOYD, LLC, P. O. BOX 1135, CHICAGO, IL, 60690-1135, US

(21) Appl. No.: 10/450,272

(22) PCT Filed: Nov. 22, 2001
(86) PCT No.: PCT/EP01/13611

(30) Foreign Application Priority Data
Dec. 11, 2000 (EP) 00127112.1

(51) Int. Cl. G10L 21/00

(52) U.S. Cl. 704/270.1

(57) ABSTRACT

The invention relates to a method for configuring a user interface for an electronic device for connecting it at least temporarily to a telecommunication or data network, comprising a voice-oriented user interface and/or a voice data entry device. The user interface or voice data entry device is configured via the telecommunication or data network by transferring at least parts of a vocabulary from a main unit in the telecommunication or data network to a terminal component of the user interface, which receives said parts of the vocabulary and saves them in an internal vocabulary memory.

The invention relates to a method for configuring a user interface for an electronic appliance in line with the precharacterizing part of claim 1. It also relates to an electronic appliance furnished with such a user interface.

Portable and, specifically, also hand-held electronic appliances can no longer be ignored in modern society and for a long time have been the subject of dynamic technical and economic development. This development made its breakthrough with the early portable transistor radios and pocket transistor radios and later experienced further peaks in the field of consumer electronics with the Walkman and the portable CD player (Discman). A similar development has already begun to emerge in this field for the MP3 player for storing pieces of music downloaded from the Internet.

Besides hand-held audio appliances, the aforementioned appliances also include the remote control units which have for a long time been customary for operating fixed television, video and hi-fi appliances and have recently also been used increasingly for controlling other appliances in the domestic sector (lighting, door and gate controls etc.).

The likewise widespread hand-held computers and data-processing appliances from the various application specifications and performance classes—ranging from the simple pocket calculator, through the programmable pocket calculator and simple address and appointment databases, to the very high-performance hand-held PC or PDA (Personal Digital Assistant)—have experienced rapid development toward higher levels of performance and complexity.

In recent years, mobile telephones and cordless telephones have gained prominent economic significance among hand-held electronic appliances. This is another area which can be noted for extremely dynamic development of performance which has resulted in modern mobile telephones having a wealth of added features and Internet access using WAP (Wireless Application Protocol).

Some time ago now, the significantly increased complexity of the functions of the aforementioned appliances led to a decline in traditional operation using simple function keys and to the increased use of voice-oriented and/or graphical user interfaces. One illustrative example of this is the operation of modern mobile telephones using a dialog system which is based on the visual display of control words, names etc. and on appropriate selection using function keys having variable assignments (“softkeys”).

Prompted by the dynamic development and the success of using voice control and voice input systems on PCs, and in conformity with the increasing complexity of the aforementioned hand-held appliances, the latter have also recently been supplied with voice control or input options to an increasing extent. Appropriately equipped remote control units—albeit only with a small vocabulary of control words available—and mobile telephones in which, in particular, control functions can be triggered and telephone numbers can be dialed by voice input are already commercially available.

Such appliances' components relating to the actual voice control or input and also the conventional voice-oriented user interfaces, which involve a particular menu being displayed visually to the user and said user being verbally requested to make inputs, are subsequently referred to as a

“dialog system” for short; more generally, a user interface is also referred to in this context.

Such user interfaces, without which highly complex modern hand-held appliances are no longer conceivable, naturally need to be produced with national-language vocabularies for international markets in order to sell the appliances on said markets. As the complexity of the aforementioned user interfaces increases, their nationalization also becomes increasingly significant, on the one hand, and increasingly complex, on the other. It entails considerable organizational or logistical problems and high costs. While low-complexity user interfaces (for example for televisions, simple remote control units and graphical user interfaces) normally have all the relevant national-language configurations held in reserve on one and the same appliance, this becomes increasingly less appropriate with increasing complexity of the user interfaces or dialog systems, and particularly for complex voice control systems.

The invention is therefore based on the object of specifying a method for configuring a user interface which significantly reduces the organizational and logistical complexity and makes distinct cost savings.

This object is achieved by a method having the features of claim 1.

The invention embraces the fundamental concept of providing the respective electronic appliance, when it is produced and delivered to the final customer, with only a rudimentary terminal component of the user interface and of allowing the respective user himself to start configuration (“nationalization”). It also embraces the concept of performing this nationalization over a communication network (e.g. the Internet, a telephone landline network or a mobile radio network) to which the appliance needs to be connected anyway or at least to which it can readily be connected. In addition, the invention covers the concept of a central station in this communication network transmitting to the terminal component at least parts of appropriate knowledge sources, specifically at least parts of one of a plurality of stored (national-language or else dialect-related) vocabularies. This configuration of the user interface is basically a final step in the manufacture of the respective appliance.

The terminal component needs to be designed to receive and to store this vocabulary and to incorporate it into the user interface. In the case of complex user interfaces with speaker-independent voice recognition, voice synthesis or voice prompts and also complex graphical user interfaces with nationalized touch-screens, the user interfaces already contain all the necessary control algorithms but the language-dependent parts of the user interface are first taken from the communication network by the final customer.

In one preferred embodiment of the invention, the vocabulary or other knowledge sources is/are transmitted to the terminal component in response to a request signal transmitted thereby. This request signal is generated, in particular, on the basis of a selection operation for a national language (or else for a dialect) by the user when starting up his terminal. Following this input, the vocabulary is then transmitted and stored automatically and “invisibly” for the user. Alternatively, the request signal can also be generated automatically on the basis of information about the user's place of residence which is held on the SIM card.

One preference for mobile radio terminals is menu guidance which starts when logging into the network and involves a national

language for nationalization being proposed to the user on the basis of the residence information which is held in his SIM card or is available from the HLR in the mobile radio network, but the user being provided with the option of an alternative choice of language. It is thus entirely possible, by way of example, for the user of a mobile telephone in Germany to decide to load English voice recognition onto his appliance, or for a resident of Switzerland to select his mother tongue from the official languages.

Within the context of the present invention, the term “national language” is also intended to cover dialects.

It is thus also possible to configure a dialect-specific user interface for parts of a particular country, for example for Bavaria and Saxony in Germany.

The telephone companies or providers generally have access to the appropriate information about the user and can themselves provide particular nationalization or regionalization variants, in which case the final stipulation should expediently be left to the user. The initialization dialogs can therefore be very brief and simple and are in no way comparable to the complicated enrollment procedures with methods of speaker-dependent voice recognition.

Alternatively, it is possible—particularly with terminals, for example mobile radio terminals, constantly connected to a communication network—for nationalization vocabularies to be transferred to the terminal in response to a control signal coming from the communication network itself. This is appropriate for updating, for example.

In preferred variants of the embodiment of the invention, user interfaces for special terminals also have differently specified vocabularies or parts of vocabularies loaded into them. Thus,

the transmitted vocabulary can comprise, in particular, national-language control words for operating the appliance, particularly for visual menu guidance and/or voice control, or else for a voice synthesis system. This will apply particularly to remote controls for controlling fixed appliances or appliance combinations in the domestic sector, where essentially only such vocabularies are required. A control vocabulary for operating a television set can, by way of example, be downloaded from a special videotext page which is created and maintained by the appliance manufacturer and/or by a television station or else by an independent service provider.

Control words also form at least part of the relevant nationalization vocabulary for telecommunication terminals and hand-held computers, however. In addition, a national-language set of names of persons and/or place names for voice control of address book or telephone book functions and/or a national-language basic vocabulary of colloquial language and also of particular technical languages—specifically for hand-held PCs or PDAs for particular professional groups—can be advantageously implemented for these appliances.

Other advantages and expediencies of the invention can be found in the subclaims and in the description below of preferred exemplary embodiments with reference to the figures, in which:

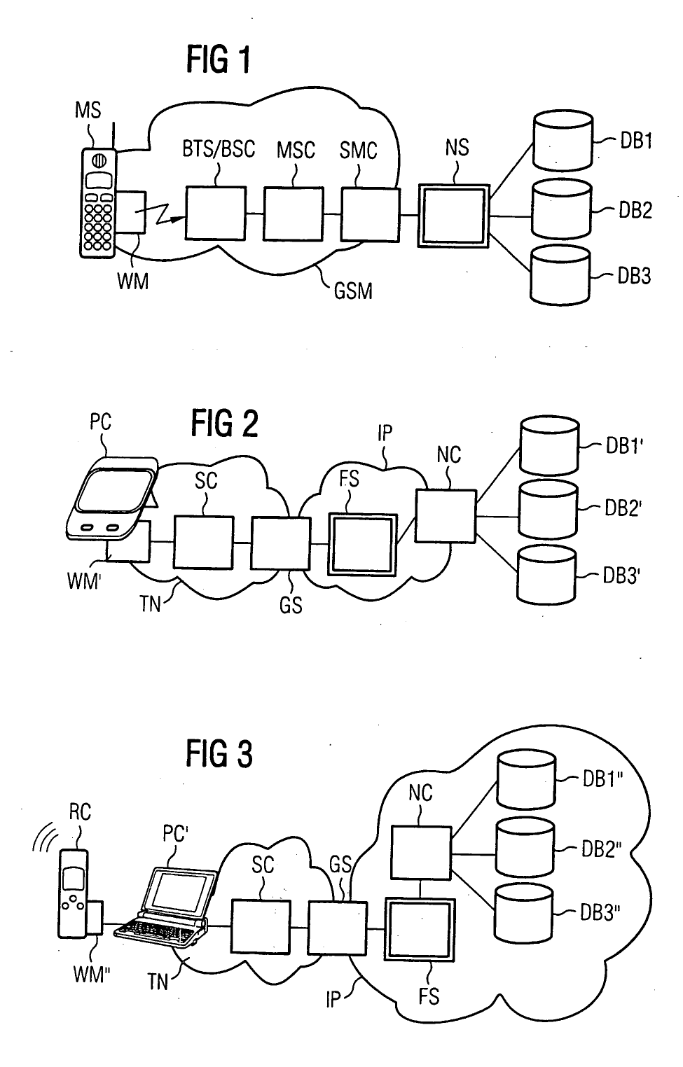

FIG. 1 shows a schematic illustration of a first embodiment of the invention (mobile telephone) in the manner of a function block diagram,

FIG. 2 shows a schematic illustration of a second embodiment of the invention (hand-held PC) in the form of a function block diagram, and

FIG. 3 shows a schematic illustration of a third embodiment of the invention (mobile remote control unit) in the manner of a function block diagram.

FIG. 1 shows how a mobile telephone MS is connected to a service and maintenance center SMC in a mobile radio network GSM in the normal manner via a base station BTS/BSC and a mobile switching center MSC. The other components in a mobile radio network based on the GSM standard are of little importance in this context and, as the design of such a network is known generally, are not described further. To carry out the inventive configuration method for the mobile telephone MS, the service and maintenance center SMC has an associated nationalization server NS to which, in turn, a plurality of vocabulary databases DB1, DB2 and DB3 containing national-language vocabularies for the mobile telephone MS in various languages are connected. The vocabulary databases contain, in particular, a selection of common names of persons in the respective national language and also an extensive control vocabulary which is sufficient for operating an added-feature mobile telephone by means of voice control.

The mobile telephone MS is delivered with the normal software, i.e. control and processing algorithms for appliance operation, but without a national vocabulary. Upon initial startup, a connection is automatically set up to the provider's service and maintenance center SMC and, on the basis of the information stored in the SIM card (not shown) relating to the telephone's place of registration, a connection is set up to that vocabulary database which holds in storage the vocabulary applicable to the appliance's place of registration.

A minimal version of menu guidance involves the user being provided with the option of confirming this vocabulary for implementation in his appliance or of selecting another national-language vocabulary. Following the

appropriate input, the network connection is used to load the vocabulary into the internal vocabulary memory WM in the mobile telephone MS. The mobile telephone is now fully functional.

The manufacture of a fully functional hand-held PC PC as shown in FIG. 2 works in a quite similar manner. In this case, a switching center SC in a telephone landline network TN and a gateway server GS are used as shown merely symbolically in the figure, on account of the arrangements being generally known—to set up a connection to a firmware server FS belonging to the manufacturer of the hand-held PC on the Internet IP. The firmware server FS has a nationalization flow controller NC implemented, which has access to a plurality of vocabulary databases DB1′ to DB3′.

When delivered, the hand-held PC has essentially been furnished with the normal software by the manufacturer, but only a minimal vocabulary or a symbol-oriented user guide which allows a connection to be set up to the firmware server FS has been implemented. When the user has set up the connection, his dialup node's national dialing code is used to ascertain which national language is most likely to need to be implemented in the appliance, and a connection is set up to the appropriate vocabulary database.

On the display, the user is informed about which national-language vocabulary is to be used to configure the user interface, and he is asked to confirm or to select another national language. Following confirmation or alternative selection, the vocabulary is loaded into the internal vocabulary memory WM′ from the appropriate vocabulary database using the nationalization flow controller NC and the Internet connection. Following this, the hand-held PC's user interface is fully configured and the hand-held PC can function without restriction. The scope of the implemented

vocabulary depends on the appliance's performance class and can comprise, besides a control vocabulary, a basic vocabulary of colloquial language and/or a selection of names of persons and geographical names. It is likewise possible for technical terminology to be provided in the vocabulary databases, however.

The finishing of a universally usable mobile remote control unit RC as shown in FIG. 3 proceeds in a basically similar manner to the configuration of the user interfaces in the arrangements shown in FIGS. 1 and 2. The remote control unit can be used, in a manner which is known per se, on an infrared, ultrasound or Bluetooth basis for operating a plurality of fixed electrical or electronic appliances in a household, and requires an appropriate national control vocabulary. Upon delivery, the algorithms required for implementing the complex control functions and also a minimal user interface have been implemented. This allows connection to a laptop PC′ and, using the latter, to a firmware server configuration via the Internet, as shown in FIG. 2. This firmware server configuration is not described again here.

Besides the circumstance that the connection to the firmware server FS is not set up directly via the landline network and the Internet, but rather using a laptop, this embodiment differs from that shown in FIG. 2 essentially only in the vocabularies implemented in the vocabulary databases DB1″ to DB3″. This is because these vocabularies essentially contain control vocabularies for audio, video and electrical domestic appliances etc., since names of persons and geographical names and also colloquial or technical language components are not required for a remote control device to work. The relatively small overall vocabulary also means that it is not appropriate to distinguish between the various sub-databases or memory areas; instead, only a distinction according to national languages is appropriate. In this case too, the selection can be made

provisionally on the basis of the dialup node used by the laptop PC′, but it is preferable for the user's Internet address or a selection made by the user at the very start to be evaluated.

Implementation of the invention is not limited to the examples outlined above, but rather is likewise possible within the scope of the claims in a multiplicity of modifications which are within the scope of technical action. In particular, combinations of individual components of the arrangements described by way of example lie within the scope of the invention.

1. A method for configuring a user interface for an electronic appliance (MS; PC; RC) for at least temporary connection to a telecommunication or data network (GSM; TN, IP), particularly for a telecommunication terminal, a hand-held PC, a remote control unit or an audio or video appliance, having a voice-oriented user interface and/or a voice input device,
characterized in that
the user interface or voice input device is configured via the telecommunication or data network, with at least parts of a voice knowledge source, particularly at least parts of a vocabulary from a plurality of stored vocabularies, being transmitted from a central station (SMC, FS) in the telecommunication or data network to a terminal component and being received therein and being stored in an internal knowledge source database, particularly an internal vocabulary memory (WM; WM′; WM″).

2. The method as claimed in claim 1,
characterized in that
the knowledge source is transmitted to the terminal component in response to a request signal coming from the latter.

3. The method as claimed in claim 2,
characterized in that
the request signal is generated by the user on the basis of a terminal identifier or input of a choice of national language, and the vocabulary is transmitted and stored automatically when the choice has been input.

4. The method as claimed in one of the preceding claims,
characterized in that
the transmitted vocabulary comprises national-language control words for operating the appliance, particularly for visual
menu guidance and/or voice control and/or voice synthesis.

5. The method as claimed in one of the preceding claims,
characterized in that
the transmitted vocabulary comprises a national-language set of names of persons and/or place names.

6. The method as claimed in one of the preceding claims,
characterized in that
the transmitted vocabulary comprises a national-language basic vocabulary of colloquial language and/or of a technical language.

7. The method as claimed in one of the preceding claims,
characterized in that
the transmitted knowledge source comprises a neural network or Hidden Markov Model prepared in national language.

8. The method as claimed in one of the preceding claims,
characterized in that
transmission of the voice knowledge source or voice knowledge sources is organized as an independent service in the telecommunication or data network (GSM; TN, IP).

9. An electronic appliance, particularly a telecommunication terminal (MS), hand-held PC (PC), remote control unit (RC), audio appliance or video appliance, having a user interface which is configured using a method as claimed in one of the preceding claims.

10. The electronic appliance as claimed in claim 9, characterized in that the user interface has voice control and/or means for voice input of text.

11. The electronic appliance as claimed in claim 8 or 9,
characterized in that
the user interface has a visual display device for displaying words or for displaying acronyms and/or graphical symbols accentuated in national language or nationally.

12. A system for carrying out the method as claimed in one of claims 1 to 8,
characterized by
a server (NS; FS) in the telecommunication or data network (GSM; TN, IP) with storage means (DB1 to DB3; DB1′ to DB3′; DB1″ to DB3″) for centrally storing the voice knowledge source or voice knowledge sources and transmission means for transmission thereof to the electronic appliance (MS; PC; RC).
